(19) United States
(12) Patent Application Publication
(10) Pub. No.: US 2013/0165197 A1
(43) Pub. Date: Jun. 27, 2013

(54) METHOD, SYSTEM AND PROGRAM PRODUCT FOR A RELATIVE MATCHING GAME

(71) Applicant: Kevin Glikmann, Woodland Hills, CA (US)

(72) Inventor: Kevin Glikmann, Woodland Hills, CA (US)

(21) Appl. No.: 13/402,789

(22) Filed: Feb. 22, 2012

Related U.S. Application Data
(60) Provisional application No. 61/578,885, filed on Dec. 22, 2011.

(51) Int. Cl. A63F 13/00

(52) U.S. Cl. 463/9

(57) ABSTRACT

A method, system and program product comprise displaying a first group of first individuals. Said displaying the first group at least comprises presenting photos of the first individuals. A second group of second individuals having potential biological relationships with the first group is displayed. Said displaying of the second group at least comprises presenting photos of the second individuals. The second group comprises at least one individual related to at least one individual of the first group. A player's choice of at least one individual from the second group being related to at least one individual of the first group is accepted. A determination of a correctness of the player choice is displayed.

### CROSS- REFERENCE TO RELATED APPLICATIONS

The present Utility patent application claims priority benefit of the U.S. provisional application for patent Ser. No. 61578885 entitled “Family Tree—Game Show Treatment”, filed on Dec. 22, 2011, under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to games. More particularly, one or more embodiments of the invention relate to gaming systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A game show is a type of radio or television program in which members of the public, television personalities or celebrities, sometimes as part of a team play game which involves answering questions or solving puzzles, often for money and/or prizes. On some game shows, contestants compete against other players or another team while other shows involve contestants playing alone.

A board game is a game which involves counters or pieces being moved on a pre-marked surface or board according to a set of rules.

A video game is an electronic game that involves human interaction with a user interface in order to generate visual feedback via a presentation device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an example presentation of placeholders and selections, in accordance with an embodiment of the present invention;

FIG. 1B is an example presentation of placeholders and selections as described with reference to FIG. 1A with information associated with a placeholder revealed, in accordance with an embodiment of the present invention;

FIG. 1C is an example presentation of placeholders and selections where information associated with placeholders is revealed;

FIG. 2 is an example presentation of clues, in accordance with an embodiment of the present invention;

FIG. 3 is an example presentation of information associated with relatives and associated potential relatives, in accordance with an embodiment of the present invention;

FIG. 4 is an example presentation of information associated with a relative, associated potential relative and unrelated person, in accordance with an embodiment of the present invention;

FIG. 5 is an example game board, in accordance with an embodiment of the present invention;

FIG. 6 is an example game show, in accordance with an embodiment of the present invention;

FIG. 7 illustrates an example method for the system as described with reference to FIGS. 1-6, in accordance with an embodiment of the present invention;

FIG. 8 illustrates a block diagram depicting a conventional client/server communication system; and

FIG. 9 illustrates a typical computer system that, when appropriately configured or designed, may serve as a computer system 900 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Some embodiments of the present invention will be described which provide means and methods for a game for matching information associated with relatives to information associated with potential relatives. Game may be represented in the form of a parlor game, video game, mobile device game, board game or television game for purposes of entertainment where players are presented with information associated with a group of similar looking people and attempt to match the person or persons that are biologically related.

In other embodiments, real people are used on a stage where contestants match/reassemble a real family from a mixture similar looking persons, or decoys, to the biologically related persons.

In other embodiments, players compete remotely via computing devices using browsing capabilities and a global communication network.

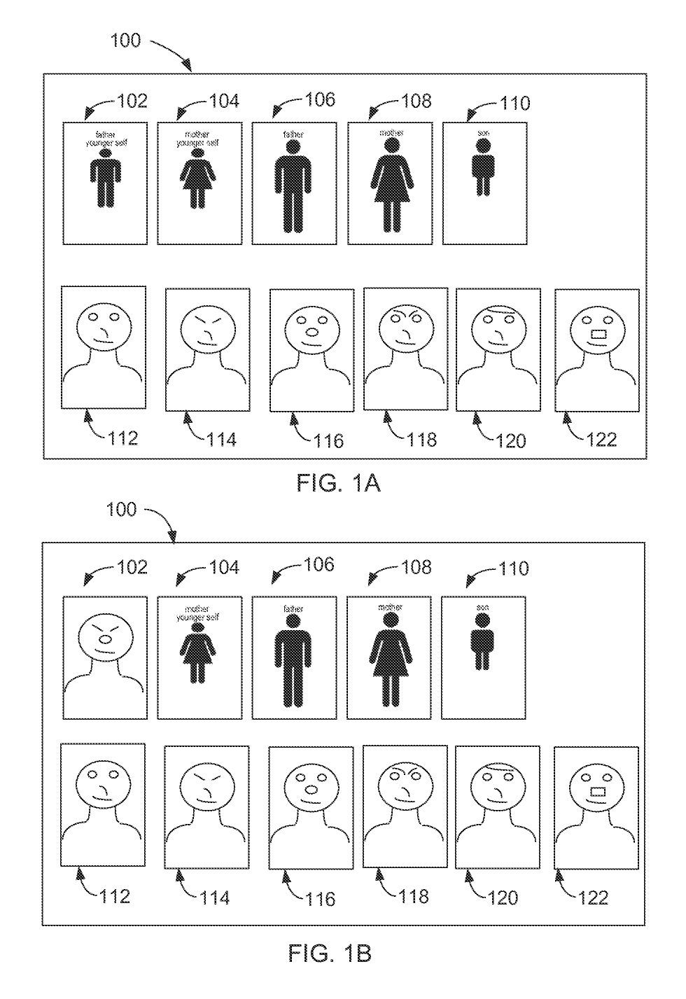

The game and gaming system will now be described in detail with reference to FIGS. 1-9.

FIG. 1A is an example presentation of placeholders and selections, in accordance with an embodiment of the present invention.

A presentation 100 includes a placeholder 102, a placeholder 104, a placeholder 106, a placeholder 108, a placeholder 110, a selection 112, a selection 114, a selection 116, a selection 118, a selection 120 and a selection 122.

Presentation 100 presents information associated with clues for a selection. Non-limiting examples of devices and means for displaying presentation 100 include cellular telephones, smartphones, notebook computing devices, netbook computing devices, laptop computing devices, mobile computing devices and desktop computing devices.

Placeholder 102, 104, 106, 108 and 110 provide a placeholder for clues prior to being revealed. Non-limiting examples for descriptions of placeholders include younger father, younger mother, present father, present mother, present son and present daughter.

Selection 112, 114, 116, 118, 120 and 122 provide information associated with persons. As a non-limiting example, a selection may represent a biological relative associated with placeholders. Non-limiting examples of information presented for selections include images, pictures and videos. Furthermore, video may contain a short clip with the person saying “hello”.

Placeholders are revealed for enabling participants to determine a match between a selection or selections and persons associated with placeholders.

Operation associated with presentation 100 is further described below with reference to FIGS. 1B-C.

FIG. 1A is an example presentation where placeholders and selections are presented for providing information and for making a selection.

FIG. 1B is an example presentation of placeholders and selections, in accordance with an embodiment of the present invention.

Presentation 100 provides placeholders and selections as described with reference to FIG. 1A with the addition information revealed for placeholder 102. For example, the image of a father from previous years associated with a selection may be presented for viewing.

FIG. 1B is an example presentation of placeholders and selections as described with reference to FIG. 1A with information associated with a placeholder revealed, in accordance with an embodiment of the present invention.

FIG. 1C is an example presentation of placeholders and selections, in accordance with an embodiment of the present invention.

Presentation 100 provides placeholders and selections as described with reference to FIG. 1A-B with the addition of information revealed for placeholders 104, 106, 108 and 110.

As a non-limiting example, the person associated with selection 112 may be biologically related to the persons associated with placeholders 102, 104, 106, 108 and 110.

Players have to find the biologically related person or persons in group A, such as, but not limited to, selections 112, 114, 116, 118, 120 and 122 based on the clues from Group B such as, but not limited to, placeholders 102, 104, 106, 108, and 110. In operation, users attempt to match biologically related person associated with selections to persons associated with placeholders.

FIG. 1C is an example presentation of placeholders and selections where information associated with placeholders is revealed.

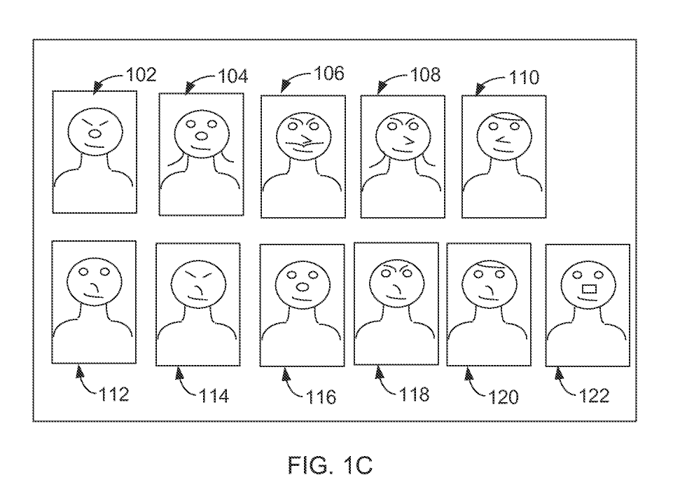

FIG. 2 is an example presentation of clues, in accordance with an embodiment of the present invention.

A presentation 200 includes a grouping 202, a grouping 204, a grouping 206, a grouping 208, a grouping 210 and a grouping 212.

Presentation 200 provides information or clues associated with a multiplicity of persons. Furthermore, persons may be biologically related or may not be biologically related. Non-limiting examples of devices and means for displaying presentation 200 include cellular telephones, smartphones, notebook computing devices, netbook computing devices, laptop computing devices, mobile computing devices and desktop computing devices.

Grouping 202, 204, 206, 208, 210 and 212 provide information for persons associated with respective grouping. Non-limiting examples of information provided via grouping 202, 204, 206, 208, 210 and 212 include images, pictures and videos.

Grouping 202 includes an information portion 214 and an information portion 216. Grouping 204 includes an information portion 218 and an information portion 220. Grouping 206 includes an information portion 222, an information portion 224, an information portion 226 and an information portion 228. Grouping 208 includes an information portion 230, an information portion 232, an information portion 234 and an information portion 236. Grouping 210 includes an information portion 238, an information portion 240, an information portion 242 and an information portion 244. Grouping 212 includes an information portion 245, an information portion 246, an information portion 248 and an information portion 250. The information portions provide information associated with persons. Non-limiting examples for information presented via the information portions include images, pictures and videos.

As a non-limiting example, the persons associated with the information presented for information portion 214 and information portion 216 are married. As a non-limiting example, the persons associated with the information portion 218 and information portion 220 are married. As a non-limiting example, the information presented via an element of grouping 206 may represent the daughter of the persons associated with grouping 202. As a non-limiting example, the information presented via an element of grouping 206 may represent persons biologically unrelated to the persons associated with grouping 202. As a non-limiting example, the information presented via an element of grouping 208 may represent the son of the persons associated with grouping 204. As a non-limiting example, the information presented via an element of grouping 208 may represent persons biologically unrelated to persons associated with grouping 204. As a non-limiting example, a person associated with grouping 206 and a person associated with grouping 208 may be married. As a non-limiting example, a person or persons associated with grouping 210 and grouping 212 may be biologically related (e.g. son, daughter, etc.) to persons associated with grouping 206 and grouping 208.

In operation, a user selects or users select an information portion associated with grouping 206 as to which information portion the user(s) consider(s) to be biologically related to the persons associated with grouping 202. Furthermore, user/users selects/select an information portion associated with grouping 208 as to which information portion the user(s) consider(s) to represent a person biologically related to the persons associated with grouping 204. Furthermore, user/users selects/select an information portion associated with grouping 210 and/or grouping 212 as to which persons associated with the information portions the user(s) consider(s) to be biologically related to the persons associated with grouping 206 and grouping 208.

FIG. 2 is an example presentation of clues where a user or users selects/select information associated with persons for determining biological relation.

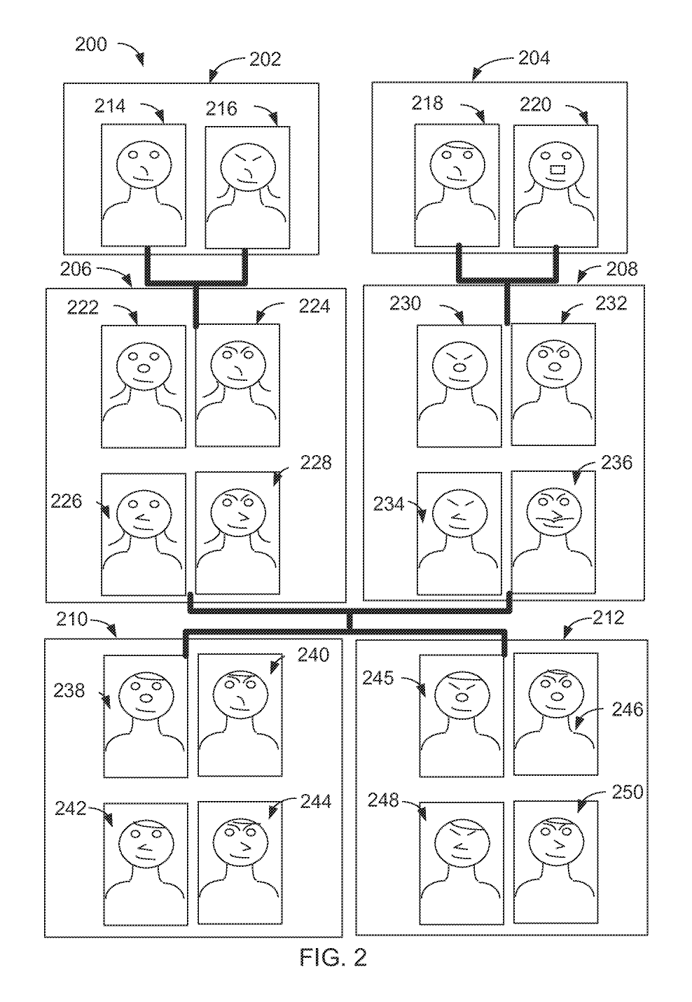

FIG. 3 is an example presentation of information associated with relatives and associated potential relatives, in accordance with an embodiment of the present invention.

A presentation 300 includes a timer portion 302, a score portion 304, a relative information portion 306, a relative information portion 308, a relative information portion 310, a relative information portion 312, a relative information portion 314, a relative information portion 316, an potential relative information portion 318, an potential relative information portion 320, an potential relative information portion 322, an potential relative information portion 324, an potential relative information portion 326, an potential relative information portion 328 and a start/stop button 330.

Presentation 300 provides information associated with relatives and their respective potential relative. Non-limiting examples of information presented include images, pictures and videos. Non-limiting examples of devices and means for displaying presentation 300 include cellular telephones, smartphones, notebook computing devices, netbook computing devices, laptop computing devices, mobile computing devices and desktop computing devices.

Timer portion 302 presents information associated with time (e.g. stop watch).

Score portion 304 presents information associated with a score.

Relative information portion 306, 308, 310, 312, 314 and 316 present information associated with relatives. Potential relative information portion 318, 320, 322, 324, 326 and 328 present information associated with potential relative.

Start/stop button 330 enables a user to select start/stop of operation.

In operation, a user selects start/stop button 330 which initiates operation. User arranges relative information portions and potential relative information portions as to which relative information portions and potential relative information portions are biologically related. As a non-limiting example, user may consider relative information portion 306 and potential relative information portion 328 as biologically related and as a result moves the location of potential relative information portion 328 below the location of relative information portion 306As another non-limiting example, user may move relative information portion 306 above potential relative information portion 328. When user is satisfied with the location of information portions, user selects start/stop button 330 to check accuracy of the matches between relative information portions and potential relative portions. When user successfully matches relative information portions with potential relative portions, incrementing of timer portion 302 terminates and the associated score is presented via score portion 304.

FIG. 3 is an example presentation of information associated with relatives and associated potential relatives where a user organizes information portions for matching relative information with potential relative information.

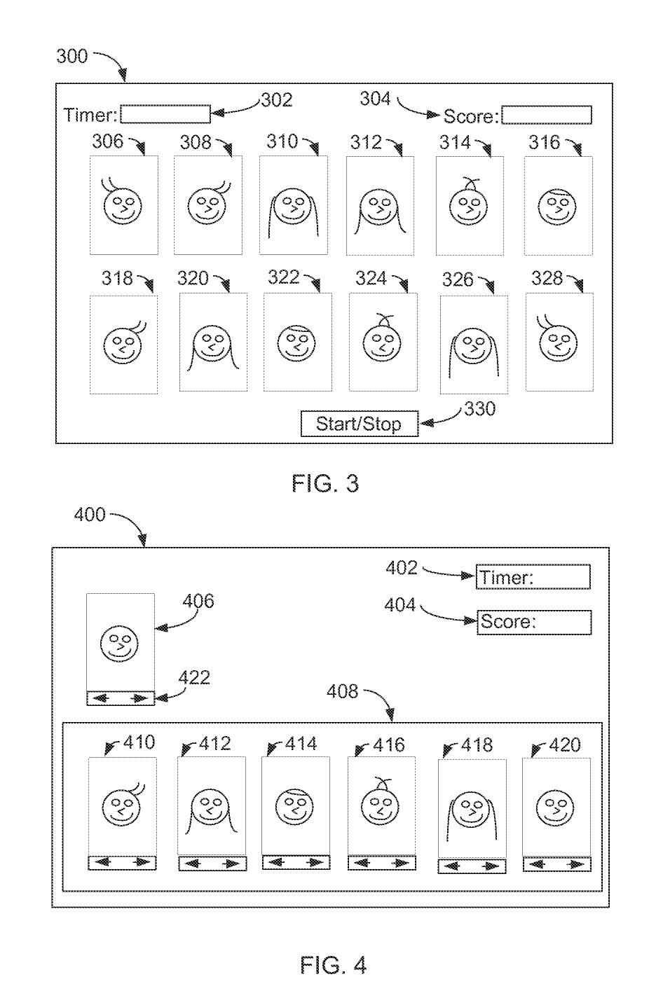

FIG. 4 is an example presentation of information associated with a relative, associated potential relative and unrelated person, in accordance with an embodiment of the present invention.

A presentation 400 includes a timer portion 402, a score portion 404, a relative information portion 406 and an potential relative selection area 408.

Presentation 400 provides information associated with a relative, potential relative and biologically unrelated persons. Non-limiting examples of devices and means for displaying presentation 400 include cellular telephones, smartphones, notebook computing devices, netbook computing devices, laptop computing devices, mobile computing devices and desktop computing devices.

Timer portion 402 provides timing information.

Score portion provides information associated with a score.

Potential relative selection area 408 provides a multiplicity of information for making a selection.

Potential relative selection area 408 includes an information portion 410, an information portion 412, an information portion 414, an information portion 416, an information portion 418 and an information portion 420.

Information portions 410, 412, 414, 416, 418 and 420 provide information associated with potential relative and biologically unrelated persons.

Relative information portion 406 and information portions, [410], 412, 414, 416, 418 and 420 provide media controls with a sampling noted as a media control 422 associated with relative information portion 406.

As a non-limiting example, user may incorrectly select information portion 418 as information associated with the person described by relative information portion 406. Furthermore, user may correctly select information portion 420 as information associated with relative information portion 406.

In operation, user is presented with presentation 400 and selects from selections located within potential relative selection area 408. Following an incorrect selection, user is presented with an opportunity to perform another selection. Following a correct selection, user is presented with a new set of information associated with relative information portion 406 and the selections associated with potential relative selection area 408. When presentation of information terminates, user may view timer portion 402 and score portion 404, in order to evaluate performance.

FIG. 4 is an example presentation of information associated with a relative, associated potential relative and unrelated person where a user attempts to match a relative with a respective potential relative.

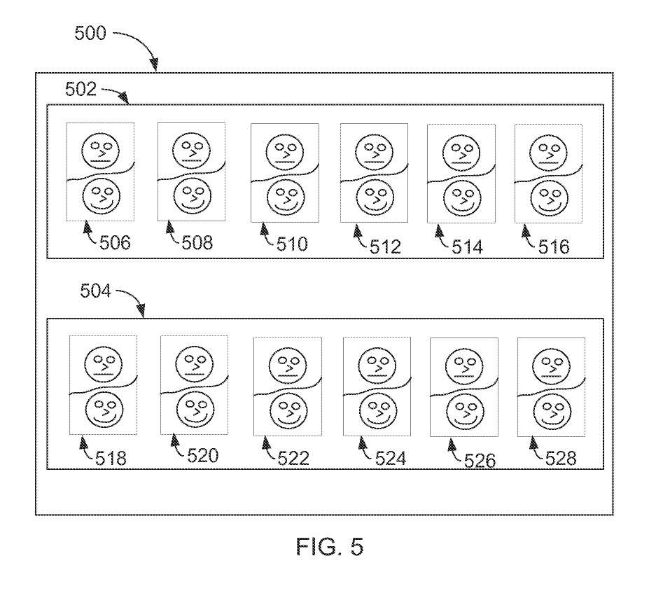

FIG. 5 is an example game board, in accordance with an embodiment of the present invention.

A game board 500 includes a relative area 502 and an potential relative 504.

Game board 500 provides capability and means for playing a game.

Relative area 502 provides capability for placing relative information cards.

Potential relative area 504 provides capability for placing potential relative information cards.

Relative area 502 includes a relative information card 506, a relative information card 508, a relative information card 510, a relative information card 512, a relative information card 514, a relative information card 516, an potential relative information card 518, an potential relative information card 520, an potential relative information card 522, an potential relative information card 524, an potential relative information card 526 and an potential relative information card 528.

Relative information cards present information associated with relatives.

Potential relative information cards present information associated with potential relative. As a non-limiting example, information cards may be presented with a multiplicity of views of person (e.g. smiling, not smiling, etc.).

In operation, players match potential relative information cards with relative potential relative information cards with the goal of successfully performing the matches in as little time as possible.

In some embodiments, matching between relative information cards and potential relative information cards is aided by informational clues.

FIG. 5 is an example game board where images of relatives are matched with respective potential relative.

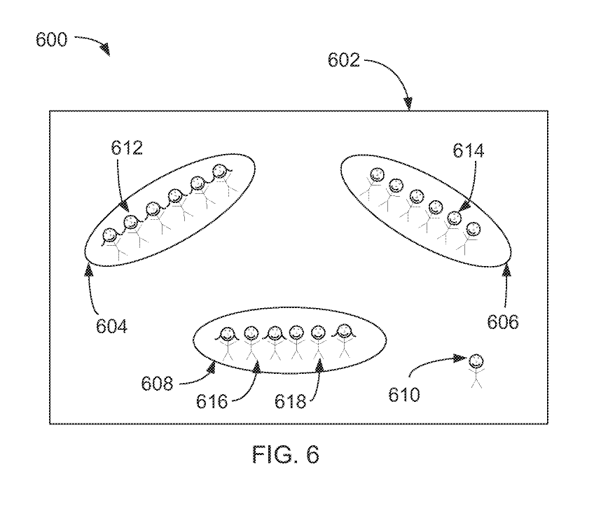

FIG. 6 is an example game show, in accordance with an embodiment of the present invention.

A game show 600 includes a stage 602, a mother area 604, a father area 606, an offspring area 608 and a contestant 610.

Game show 600 provides capability and means for performing a game show.

Mother area 604 provides a location for mothers. Father area 606 provides a location for fathers. Offspring area 608 provides a location for offspring. Contestant 610 is a contestant of game show.

Mother area 604 includes a multiplicity of mothers with a sampling noted as a mother 612. Father area 606 includes a multiplicity of fathers with a sampling noted as a father 614. Offspring area 608 includes a multiplicity of offspring with a sampling noted as an offspring 616 and an offspring 618.

In operation, contestant 610 attempts to match the offspring associated with offspring area 608 with the respective mother associated with mother area 604 and with the respective father associated with father area 606. As a non-limiting example, contestant may match the mother and father of offspring 616 and offspring 618 as mother 612 and father 614, respectively.

In other embodiments, information associated with mothers, fathers and offspring may be presented in picture, image or video format. As a non-limiting example, information presented may be provided by individuals and families. Information may be sorted based upon various criteria. Non-limiting examples of criteria include age, race, eye color, skin color and hair color.

In other embodiments, a multiplicity of contestants may participate and compete. In other embodiments a multiplicity of rounds may be executed with different levels of difficulty. In other embodiments, speed rounds may be executed where a player attempts to match as many parents and offspring as possible in an amount of time. In other embodiments, a final may be performed in order to select an overall winner.

In other embodiments, two families compete by solving photo-genetic puzzles, where, in one case, a photo of a child is to be correctly selected from a group of similarly looking children using photo clues consisting of the child's relatives, ie. parents, siblings, etc. The winning family of the Photo-Genetic rounds then tries to reassemble, on stage, a family mixed together with similar looking people for a chance to double their winnings Located on stage is a host, and two families sitting opposite one other on couches. In front of the families are Graphical User Interfaces (GUIs). Downstage two presentation devices are provided, standing approximately three feet off the ground, set at a 45 degree angle, as a non-limiting example. Finally, upstage on the back wall is a large jumbo screen. For the qualifying round, five families surround the stage. The families stand in front of large touch screens. The families are presented a Photo-Genetic puzzle where they have to select the two siblings. The fastest family to successfully complete the puzzle becomes the next family contestant. For the first show, the two fastest families compete against one other. Thereafter, they compete against the family used in the bonus round. The bonus round is described further in the following paragraphs. The family from the qualifying round decides if they want to go first. For the first show the fastest family from the qualifying round decides if they want to go first. The family that goes first builds a Photo-Genetic puzzle for the other family. They choose the order of the clues and select five decoy children from a photo library for the individual puzzle. Their goal is to make the puzzle as difficult as possible since the longer it takes their opponent to successfully complete the puzzle the more money they make. Once the family finishes building the puzzle, the host reveals the puzzle to the opposing family and the audience. The family solving the puzzle asks the host for the first clue to be revealed. After the first clue is revealed a money timer starts adding money per second of time. Subsequent clues used to aid in solving the puzzle add $1,000, as a non-limiting example, to the money timer. A wrong answer given adds $2,500 to the timer, as a non-limiting example. The money timer stops when the family selects the correct answer. The total money on the timer goes to the family who constructed the puzzle. The families continue this round-robin build/puzzle solution game play for two rounds, as a non-limiting example. For the family tree round, families stand in front of associated GUIs. A three generational family tree is presented where the last generation is the children. The clues for the first generation, the grandparents for the two sides of the family, are revealed. The rest of the lineage associated with the family tree is hidden. The Host asks the families to generate a secret bet from their total winnings associated with the first unseen family member. The bet can be from zero to a family's total winnings. The host explains that family members have been mixed together with three other similar looking people. The four pictures are revealed one at a time. Anytime following the revealing of the first photo is revealed and a family has a response they can hit their buzzer and announce who they think is the offspring. If they are correct they collect their bet plus their opponents bet. In other words, if first family has $10,000 total and bets $2,000 and loses then the associated new total is $8,000. This game play continues for the rest of the family tree puzzle. The family with the most money following the three photo-genetic puzzle rounds wins and keeps their winnings and prizes. This family also moves on to the bonus round to compete for a chance to double their money.

For the bonus round, the winning family now reassembles a real family on stage mixed together with similar looking people within a two minute time constraint, as a non-limiting example. In other words, the mother is mixed together with three other women who look similar to her, as a non-limiting example. The father is mixed together with three other men who look similar to him, as a non-limiting example. The sibling(s) is/are mixed together with three others that look similar to them, as a non-limiting example. Success in reassembling the family within the time constraint results in a doubling of winnings When participants think they have chosen a correct family, a member takes a digital photograph of the reassembled family which appear on the large game screen. however, only the correct family members appear in the digital photograph. If not all family members appear in the photograph then the participants must try a different combination of family members and take another photograph to see who is correct. This game play continues until time expires or the family is reassembled correctly. The reassembled family becomes the next contestant on the show. The game starts over with the Qualifying round to find the next competing family.

FIG. 6 is an example game show where persons match parents with offspring associated with certain constraints in order to win the game show.

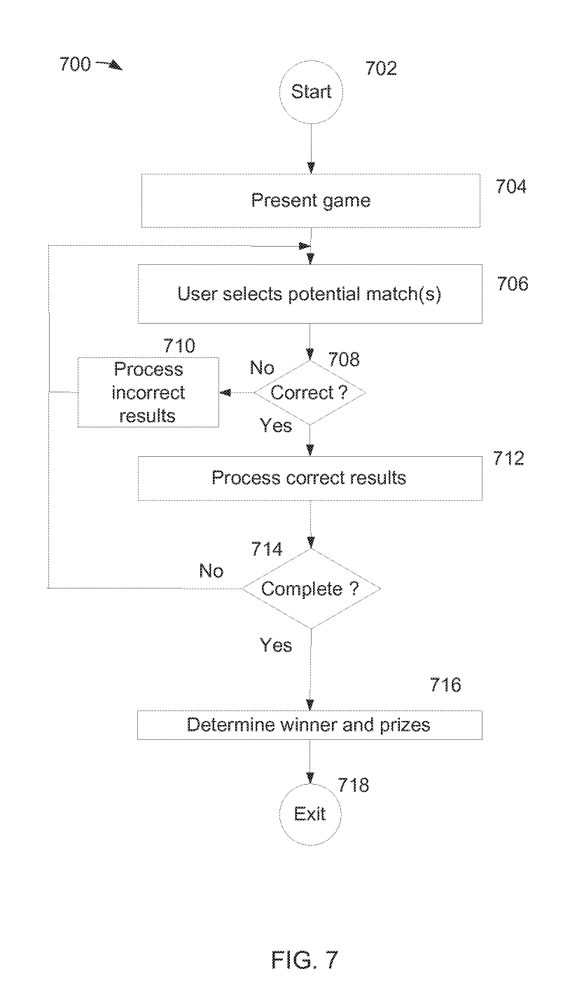

FIG. 7 illustrates an example method for the system as described with reference to FIGS. 1-6, in accordance with an embodiment of the present invention.

A method 700 initiates in a step 702.

Then in a step 704, game is presented to user.

Then in a step 706, user selects a potential match or potential matches.

Then in a step 708, a determination is performed for a correct selection.

For a determination of an incorrect selection in step 708, in a step 710, the incorrect selection is processed.

For a determination of a correct selection in step 706, in a step 712 the correct selection is processed.

Then in a step 714, a determination is performed for a complete game.

For a determination of an incomplete game in step 714, execution of method 700 transitions to step 706.

For a determination of a complete game in step 714, a determination for a winner and associated prizes is performed in a step 716.

Then in a step 718, execution of method 700 is terminated.

FIG. 7 illustrates an example method for the system as described with reference to FIGS. 1-6 where a user/player plays a game where user/player attempts to match information associated with relatives to information associated with potential relatives for purposes of playing and winning a game.

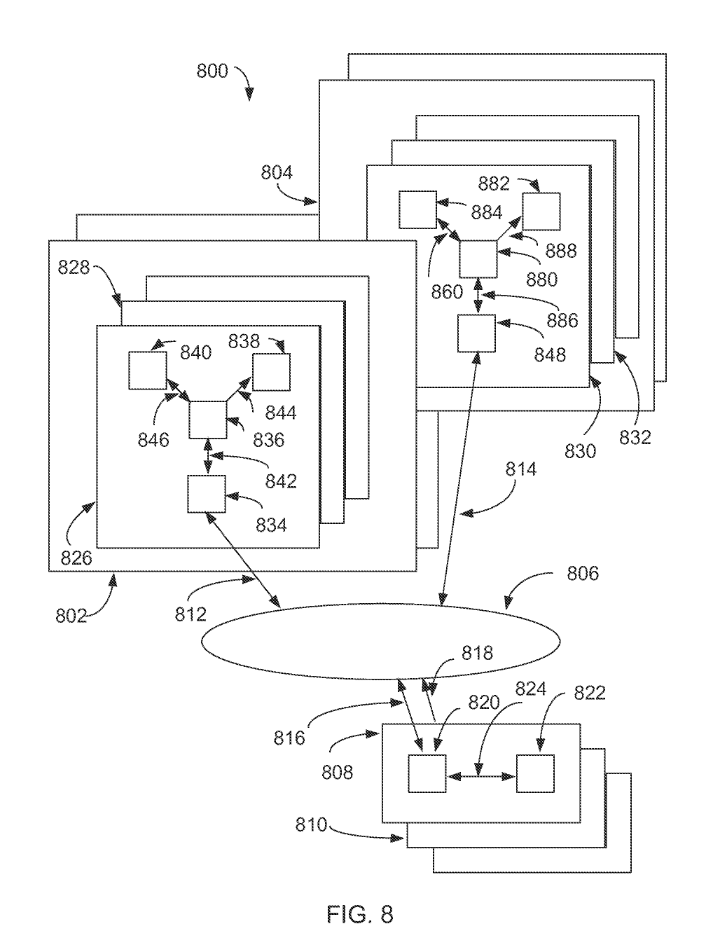

FIG. 8 illustrates a block diagram depicting a conventional client/server communication system.

A communication system 800 includes a multiplicity of networked regions with a sampling of regions denoted as a network region 802 and a network region 804, a global network 806 and a multiplicity of servers with a sampling of servers denoted as a server device 808 and a server device 810.

Network region 802 and network region 804 may operate to represent a network contained within a geographical area or region. Non-limiting examples of representations for the geographical areas for the networked regions may include postal zip codes, telephone area codes, states, counties, cities and countries. Elements within network region 802 and 804 may operate to communicate with external elements within other networked regions or within elements contained within the same network region.

In some implementations, global network 806 may operate as the Internet. It will be understood by those skilled in the art that communication system 800 may take many different forms. Non-limiting examples of forms for communication system 800 include local area networks (LANs), wide area networks (WANs), wired telephone networks, cellular telephone networks or any other network supporting data communication between respective entities via hardwired or wireless communication networks. Global network 806 may operate to transfer information between the various networked elements.

Server device 808 and server device 810 may operate to execute software instructions, store information, support database operations and communicate with other networked elements. Non-limiting examples of software and scripting languages which may be executed on server device 808 and server device 810 include C, C++, C# and Java.

Network region 802 may operate to communicate bi-directionally with global network 806 via a communication channel 812. Network region 804 may operate to communicate bi-directionally with global network 806 via a communication channel 814. Server device 808 may operate to communicate bi-directionally with global network 806 via a communication channel 816. Server device 810 may operate to communicate bi-directionally with global network 806 via a communication channel 818. Network region 802 and 804, global network 806 and server devices 808 and 810 may operate to communicate bi-directionally and also communicate bi-directionally with other networked device located within communication system 800.

Server device 808 includes a networking device 820 and a server 822. Networking device 820 may operate to communicate bi-directionally with global network 806 via communication channel 816 and with server 822 via a communication channel 824. Server 822 may operate to execute software instructions and store information.

Network region 802 includes a multiplicity of clients with a sampling denoted as a client 826 and a client 828. Client 826 includes a networking device 834, a processor 836, a GUI 838 and an interface device 840. Non-limiting examples of devices for GUI 838 include monitors, televisions, cellular telephones, smartphones and PDAs (Personal Digital Assistants). Non-limiting examples of interface device 840 include pointing device, mouse, trackball, scanner and printer. Networking device 834 may communicate bi-directionally with global network 806 via communication channel 812 and with processor 836 via a communication channel 842. GUI 838 may receive information from processor 836 via a communication channel 844 for presentation to a user for viewing. Interface device 840 may operate to send control information to processor 836 and to receive information from processor 836 via a communication channel 846. Network region 804 includes a multiplicity of clients with a sampling denoted as a client 830 and a client 832. Client 830 includes a networking device 848, a processor 880, a GUI 882 and an interface device 884. Non-limiting examples of devices for GUI 838 include monitors, televisions, cellular telephones, smartphones and PDAs (Personal Digital Assistants). Non-limiting examples of interface device 840 include pointing devices, mousse, trackballs, scanners and printers. Networking device 848 may communicate bi-directionally with global network 806 via communication channel 814 and with processor 880 via a communication channel 886. GUI 882 may receive information from processor 880 via a communication channel 888 for presentation to a user for viewing. Interface device 884 may operate to send control information to processor 880 and to receive information from processor 880 via a communication channel 860.

For example, consider the case where a user interfacing with client 826 may want to execute a networked application. A user may enter the IP (Internet Protocol) address for the networked application using interface device 840. The IP address information may be communicated to processor 836 via communication channel 846. Processor 836 may then communicate the IP address information to networking device 834 via communication channel 842. Networking device 834 may then communicate the IP address information to global network 806 via communication channel 812. Global network 806 may then communicate the IP address information to networking device 820 of server device 808 via communication channel 816. Networking device 820 may then communicate the IP address information to server 822 via communication channel 824. Server 822 may receive the IP address information and after processing the IP address information may communicate return information to networking device 820 via communication channel 824. Networking device 820 may communicate the return information to global network 806 via communication channel 816. Global network 806 may communicate the return information to networking device 834 via communication channel 812. Networking device 834 may communicate the return information to processor 836 via communication channel 842. Processor 836 may communicate the return information to GUI 838 via communication channel 844. User may then view the return information on GUI 838.

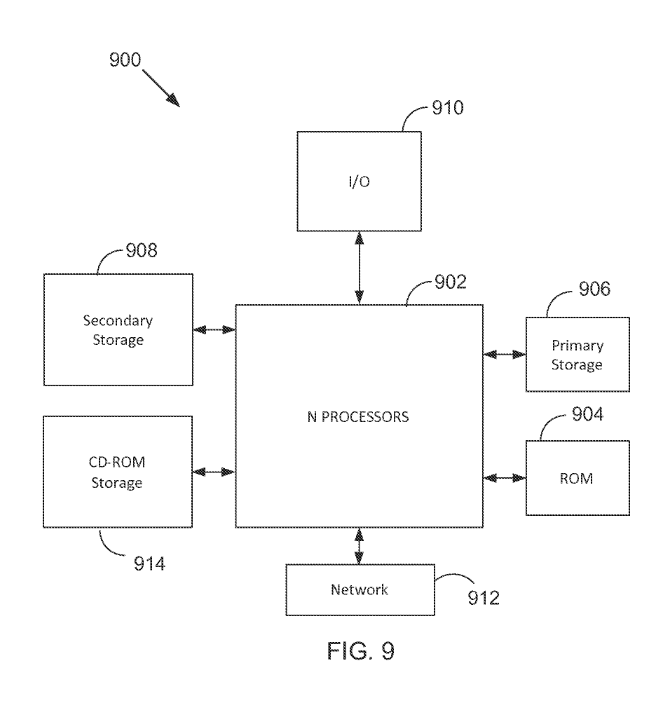

FIG. 9 illustrates a typical computer system that, when appropriately configured or designed, may serve as a computer system 900 for which the present invention may be embodied.

Computer system 900 includes a quantity of processors 902 (also referred to as central processing units, or CPUs) that may be coupled to storage devices including a primary storage 906 (typically a random access memory, or RAM), a primary storage 904 (typically a read-only memory, or ROM). CPU 902 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 904 acts to transfer data and instructions uni-directionally to the CPU and primary storage 906 typically may be used to transfer data and instructions in a bi-directional manner. The primary storage devices discussed previously may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and typically may be used as a secondary storage medium such as a hard disk. It will be appreciated that the information retained within mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection shown generally as a network 912, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of games and gaming systems according to the present invention will be apparent to those skilled in the art. The invention has been described above by way of illustration, and the specific embodiments disclosed are not intended to limit the invention to the particular forms disclosed. For example, the particular implementation of the GUI may vary depending upon the particular type of computing device used. The computing devices described in the foregoing were directed to laptop computing implementations; however, similar techniques using television implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

1. (canceled)

2. (canceled)

3. (canceled)

4. (canceled)

5. (canceled)

6. (canceled)

7. (canceled)

8. (canceled)

9. (canceled)

10. (canceled)

11. A system as recited in claim 27, in which the photographs further include multiple photographs for at least one of the individuals.

12. A system as recited in claim 11, in which the multiple photographs at least include photographs taken at different ages.

13. A system as recited in claim 11, in which the multiple photographs at least include photographs with varying facial expressions.

14. The system as recited in claim 11, further including an acceptance mechanism which accepts the player's choice to view one or more of the multiple photographs of a selected individual and a presentation mechanism which presents the player's choice.

15. A system as recited in claim 27, in which said means for displaying the first group and said displaying the second group further comprise presenting video clips.

16. A system as recited in claim 15, includes a selection mechanism for the player to make a choice to view a video clip of a selected individual and a presentation mechanism for presenting the player's choice.

17. A system as recited in claim 27, in which said input device includes a matching mechanism which allows the player to match related individuals from the second group to individuals of the first group.

18. A system as recited in claim 27, further including an enabling mechanism which enables multiple players to make choices.

19. (canceled)

20. (canceled)

21. (canceled)

22. (canceled)

23. (canceled)

24. (canceled)

25. (canceled)

26. (canceled)

27. A system comprising:
a. a computer;
b. a monitor coupled to said computer wherein said monitor displays both a first group of first individuals and presents photographs of the first individuals and a second group of second individuals having potential biological relationships with the first individuals of the first group and which presents photographs of the second individuals wherein the second group includes at least one individual related to at least one individual of the first group; and
c. an input device coupled to said computer whereby a player inputs into said computer his choice of at least one individual from the second group being related to at least one individual of the first group and said computer makes a determination of the correctness of the player's choice so that said monitor displays said determination of the correctness of the player's choice.
